(19) United States
(12) Patent Application Publication
(10) Pub. No.: US 2011/0317972 A1
(43) Pub. Date: Dec. 29, 2011

(54) Optical device, optical arrangement and optical element holder

(75) Inventors: Qingxin Zhang, Singapore (SG); Chee Wei TAN, Singapore (SG); Yu DU, Singapore (SG); Guo Qiang Patrick Lo, Singapore (SG)

(73) Assignee: Agency for Science, Technology and Research

(21) Appl. No.: 13/135,064

(22) Filed: Jun. 24, 2011

(30) Foreign Application Priority Data
Jun. 25, 2010 (SG) 201004594-6

(51) Int. Cl. G02B 6/00; C23F 1/00

(52) U.S. Cl. 385/135; 216/37

(57) ABSTRACT

Embodiments provide an optical device including a carrier; a light source; a receiving chamber in or on the carrier wherein the receiving chamber is configured to receive an optical element; the optical element received in the receiving chamber; a plurality of actuators; and a waveguide arranged to receive light transmitted from the light source through the optical element. At least one of the receiving chamber and the actuators is arranged and configured to adjust the position of the optical element in the receiving chamber in a first direction perpendicular to the main surface of the carrier and in a second direction in-plane with the main surface of the carrier.

The present application claims the benefit of the Singapore patent application 201004594-6 filed on 25 Jun. 2010, the entire contents of which are incorporated herein by reference for all purposes.

### FIELD OF THE INVENTIONS

Embodiments relate generally to an optical device, an optical arrangement and an optical element holder.

### BACKGROUND OF THE INVENTIONS

Silicon photonics, which is compatible with the main stream CMOS manufacturing process, has the potential to realize a low cost optical communication system. Due to the lack of an efficient silicon optical source, it is required to integrate a discrete laser diode (LD) to realize a complete transmission system. Light coupling from LD to photonics chip with small core waveguide, and vice versa, remains one of the most expensive and time consuming process in the packaging of silicon photonics. Microelectromechanical systems (MEMS) active alignment is an attractive approach with high potential to replace the conventional alignment equipment, as it can accommodate not only optical fibers and integrated devices, but also “on-chip” micro-actuators for aligning and fixing of optical elements on a single substrate. Extensive studies on MEMS active alignment have been conducted with major focus on the alignment and fixing of optical fibers in an optical system.

### SUMMARY

Various embodiments provide an optical device including a carrier; a light source; a receiving chamber in or on the carrier wherein the receiving chamber is configured to receive an optical element; the optical element received in the receiving chamber; a plurality of actuators; and a waveguide arranged to receive light transmitted from the light source through the optical element. At least one of the receiving chamber and the actuators is arranged and configured to adjust the position of the optical element in the receiving chamber in a first direction perpendicular to the main surface of the carrier and in a second direction in-plane with the main surface of the carrier.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows an optical device according to an embodiment.

FIG. 2 shows a close view of the optical device according to an embodiment.

FIG. 3 shows an optical element holder according to an embodiment.

FIG. 4 shows an optical device according to an embodiment.

FIG. 5 shows the cross-sectional view of the optical device of FIG. 4 according to an embodiment.

FIG. 6 illustrates the 3-D holding mechanism of an optical element holder according to an embodiment.

FIG. 7(a)-7(e) illustrates the alignment and locking process of an optical device according to an embodiment.

FIG. 8 shows a process illustrating a method for fabricating the optical element holder according to an embodiment.

FIG. 9 shows the SEM micrographs of a fabricated optical element holder structure according to an embodiment.

FIG. 10 shows an optical device assembly according to an embodiment.

FIG. 11 shows the simulated maximum displacement of the actuator as a function of the geometric dimensions according to an embodiment.

FIG. 12 shows 3D simulation of an optical element holder under forces along three directions according to an embodiment.

FIG. 13 shows a schematic experiment setup for testing optical coupling using MEMS actuators according to an embodiment.

FIG. 14 shows the characterization of the actuators according to an embodiment.

FIG. 15(a) illustrates coupling loss of waveguide-to-laser diode versus the alignment of the ball lens according to an embodiment. FIG. 15(b) illustrates coupling loss of fiber-to-waveguide versus the alignment of the ball lens according to an embodiment.

FIG. 16 illustrates the optical coupling loss versus the displacement according to an embodiment.

### DETAILED DESCRIPTION OF THE INVENTIONS

Various embodiments provide an optical device, an optical arrangement, an optical element holder and a method for fabricating an optical element holder. Various embodiments provide active and precise alignment of optical components, such as fibers and lens, in photonics packaging and assembly.

An embodiment is directed to an optical device. The optical device may include a carrier; a light source; a receiving chamber in or on the carrier wherein the receiving chamber is configured to receive an optical element; the optical element received in the receiving chamber; a plurality of actuators; and a waveguide arranged to receive light transmitted from the light source through the optical element. At least one of the receiving chamber and the actuators is arranged and configured to adjust the position of the optical element in the receiving chamber in a first direction perpendicular to the main surface of the carrier and in a second direction in-plane with the main surface of the carrier.

In an embodiment, the carrier may include a silicon substrate. In another embodiment, the carrier may include a silicon on insulator (SOI) substrate.

The carrier may be a MEMS (microelectromechanical systems) platform, on which the receiving chamber and the plurality of actuators are arranged. The MEMS platform may provide active alignment of optical elements received on the MEMS platform. The receiving chamber may be a groove, for example, a V-shape groove, for holding/receiving the optical element. The V-groove may be formed by extension parts of two opposite slope wedges in an embodiment. The slope wedges may include silicon.

The actuators may be selected from electrical actuators, thermal actuators, electro-thermal actuators or piezoelectric actuators. In an embodiment, the actuator may include a plurality of parallel V-beams.

The optical element may include a prism, a fiber or a lens, e.g., a ball lens, for coupling light from the light source to the waveguide. In an embodiment, the light source may be a laser, e.g. a laser diode, or other types of light source, e.g. a light emitting diode. In other embodiments, the optical device may include other types of photonics chip other than the waveguide.

In an embodiment, the optical device may further include an optical element holder positioned above the receiving chamber and configured to hold the optical element in a pre-defined position.

The optical element holder may be configured to limit the movement of the optical element in the first direction perpendicular to the main surface of the carrier, and in a third direction in-plane with the main surface of the carrier and perpendicular to the second direction.

In an embodiment, the optical element holder may include a biasing structure to hold the optical element in the pre-defined position. The biasing structure may include at least one spring. In an example, the spring may be a serpentine spring. The spring may include silicon. In other embodiments, other types of elastic object may be used in the biasing structure to allow and at the same time limit the movement of the optical element in the first direction.

In another embodiment, the optical element holder may include a groove on the bottom side engaging the optical element. The groove may be a V-groove, the longitudinal direction of which may be parallel to the second direction, so as to guide the movement of the optical element along the second direction and limit the movement of the optical element in the third direction.

According to an embodiment, at least one of the receiving chamber and the actuators is arranged and configured to adjust the position of the optical element in the receiving chamber in one or two directions in-plane with the main surface of the carrier. In an embodiment, the actuators may be configured to control the receiving chamber, e.g. to move the slope wedges in-plane with the main surface of the carrier, so as to adjust the position of the optical element in the receiving chamber in one or two directions in-plane with the main surface of the carrier. In another embodiment, the actuators may be configured to control the receiving chamber to adjust the position of the optical element in the first direction perpendicular to the main surface of the carrier. The actuators may be powered-on during the adjustment/alignment of the position of the optical element, and may be powered-off after the adjustment/alignment.

According to an embodiment, the optical device may include one or more suspension arms arranged on the carrier and connected to the receiving chamber. The suspension arms may be movable under the control of the actuators to adjust the position of the optical element in the receiving chamber in one or two directions in-plane with the main surface of the carrier. In an embodiment, the suspension arms may be connected to the slope wedges of the receiving chamber. In another embodiment, the suspension arms may include slope wedges at one end of the arms, wherein the slope wedges are arranged opposite to each other to form the receiving chamber.

According to an embodiment, the optical device further includes at least one locking arm configured to lock the receiving chamber in a pre-defined position. The locking arm may be arranged relative to the receiving chamber and/or the suspension arms to restrict the movement of the receiving chamber and/or the suspension arms, so as to fix the position of the optical element. In an embodiment, a respective set of locking arm may be configured perpendicularly to each suspension arm with teeth on the locking arm engaged with their counterparts in the suspension arm, so as to restrict the movement of the suspension arms. The locking arm may be a micro-mechanical locking mechanism.

Various embodiments described above provide an optical device, in which the optical element are aligned with the light source and the waveguide by the MEMS platform carrier which includes integrated MEMS actuators with both micro-positioning and micro-locking functions to provide 2-D in-packaging alignment. Various embodiments also provide an optical device, in which an optical element holder is attached to the MEMS platform carrier to limit the movement of the optical element in the direction perpendicular to the main surface of the carrier, so as to provide 3-D in-packaging active alignment of optical elements.

Another embodiment is directed to an optical device. The optical device may include a carrier; a receiving chamber in or on the carrier wherein the receiving chamber is configured to receive an optical element; the optical element received in the receiving chamber; and a plurality of actuators. At least one of the receiving chamber and the actuators is arranged and configured to adjust the position of the optical element in the receiving chamber in a direction perpendicular to the main surface of the carrier.

Similar to the embodiments described above, the carrier may include a silicon substrate, or a silicon on insulator (SOI) substrate. The carrier may be a MEMS platform, on which the receiving chamber and the plurality of actuators are arranged. The receiving chamber may be a groove, for example, a V-shape groove, which may be formed by extension parts of two opposite slope wedges in an embodiment. The slope wedges may include silicon.

The actuators may be selected from electrical actuators, thermal actuators, electro-thermal actuators or piezoelectric actuators. In an embodiment, the actuator may include a plurality of parallel V-beams.

The optical element may include a prism, a fiber or a lens, e.g., a ball lens, for coupling light from the light source to the waveguide.

According to an embodiment, at least one of the receiving chamber and the actuators is arranged and configured to adjust the position of the optical element in the receiving chamber in one or two directions in-plane with the main surface of the carrier. In an embodiment, the actuators may be configured to control the receiving chamber, e.g. to move the slope wedges in-plane with the main surface of the carrier, so as to adjust the position of the optical element in the receiving chamber in one or two directions in-plane with the main surface of the carrier. In another embodiment, the actuators may be configured to control the receiving chamber to adjust the position of the optical element in the first direction perpendicular to the main surface of the carrier. The actuators may be powered-on during the adjustment/alignment of the position of the optical element, and may be powered-off after the adjustment/alignment.

A further embodiment is directed to an optical arrangement. The optical arrangement includes an optical element holder for holding an optical element against a receiving chamber of a carrier. The optical element holder may include a frame, a biasing structure arranged in the frame, and a suspended mass supported by the biasing structure and arranged in the top surface of the frame. The suspended mass is movable in a direction perpendicular to the top surface of the optical element holder to hold the optical element in a pre-defined position, and the optical element holder is configured to hold the optical element under the suspended mass in the frame. The optical arrangement further includes the optical element received in the frame of the optical element holder.

In an embodiment, the frame and the mass may include at least one of silicon, silicon oxide, silicon nitride and metal layers, such as Al, Cr, Au, alloy and any combination thereof.

The optical element may include a prism, a fiber or a lens, e.g., a ball lens, for coupling light from a light source to a photonics device.

According to an embodiment, the optical element holder is a MEMS structure.

In an embodiment, the biasing structure may include at least one spring. In an example, the spring may be a serpentine spring. The spring may include one or more of silicon, silicon oxide, silicon nitride and metal layers, such as Al, Cr, Au, alloy and any combination thereof. In other embodiments, other types of elastic object may be used in the biasing structure to allow and at the same time limit the movement of the optical element in the direction perpendicular to the top surface of the optical element holder.

According to an embodiment, the optical element holder is configured to limit the movement of the optical element in the direction perpendicular to the top surface of the optical element holder. For example, the suspended mass supported by the biasing structure may limit the movement of the optical element which is held under the suspended mass. The top surface of the optical element holder may be parallel to the main surface of the carrier when the optical element is held between the optical element holder and the carrier.

According to an embodiment, the suspended mass may include a groove on the bottom side, wherein the groove is configured to engage the optical element. The groove may be a V-groove, for example. The groove may guide the movement of the optical element along the longitudinal direction of the groove, and may limit the movement of the optical element in a direction in-plane with the main surface of the carrier and perpendicular to the longitudinal direction of the groove.

According to an embodiment, the optical element holder is attached to the carrier and is arranged above the receiving chamber of the carrier to hold the optical element between the optical element holder and the receiving chamber. The optical element holder, the carrier and the optical element held in between may form an optical device with the optical element aligned with other photonics chip and fixed on the carrier.

In an embodiment, the carrier may include a plurality of actuators. At least one of the receiving chamber and the actuators is arranged and configured to adjust the position of the optical element in the receiving chamber in a direction perpendicular to the main surface of the carrier and in a direction in-plane with the main surface of the carrier.

In an embodiment, the optical device may include one or more suspension arms arranged on the carrier and connected to the receiving chamber. The suspension arms may be movable under the control of the actuators to adjust the position of the optical element in the receiving chamber in one or two directions in-plane with the main surface of the carrier.

Another embodiment is directed to an optical element holder for holding an optical element against a receiving chamber of a carrier. The optical element holder may include a frame; a biasing structure arranged in the frame; a suspended mass supported by the biasing structure and arranged in the top surface of the frame. The suspended mass may be movable in a direction perpendicular to the top surface of the optical element holder to hold the optical element in a pre-defined position.

A further embodiment is directed to a method for operating an optical device, wherein the optical device includes a carrier, an optical element holder and an optical element held by the optical element holder against a receiving chamber of the carrier. The method includes disengaging at least one locking arm from the receiving chamber, wherein the locking arm is arranged on the carrier to lock the receiving chamber in a pre-defined position. The method may further include moving at least one suspension arms arranged on the carrier and connected to the receiving chamber, thereby adjusting the position of the receiving chamber. The method further includes engaging the locking arm to the receiving chamber, thereby locking final positions of the receiving chamber and the optical element received in the receiving chamber.

A further embodiment is directed to a method for fabricating an optical element holder. The method may include depositing an oxide layer on a substrate; patterning the oxide layer to form a biasing structure and a suspended mass; etching from the back side of the substrate to form a first groove under the biasing structure and the suspended mass; etching from the first groove to form a second groove within the suspended mass wherein the size of the second groove is smaller than the size of the first groove; forming one or more metal pads on the back side of the substrate; etching from the first groove to form one or more third grooves under the biasing structure; and etching from the front side of the substrate to release the biasing structure and the suspended mass from the underlying substrate.

The embodiments will be described with reference to the figures in the following. In the figures, the optical element is shown as a ball lens. However, it is understood that the optical element described in the figures may include various types of optical elements such as e.g. fiber element(s), one or more prisms, and the like.

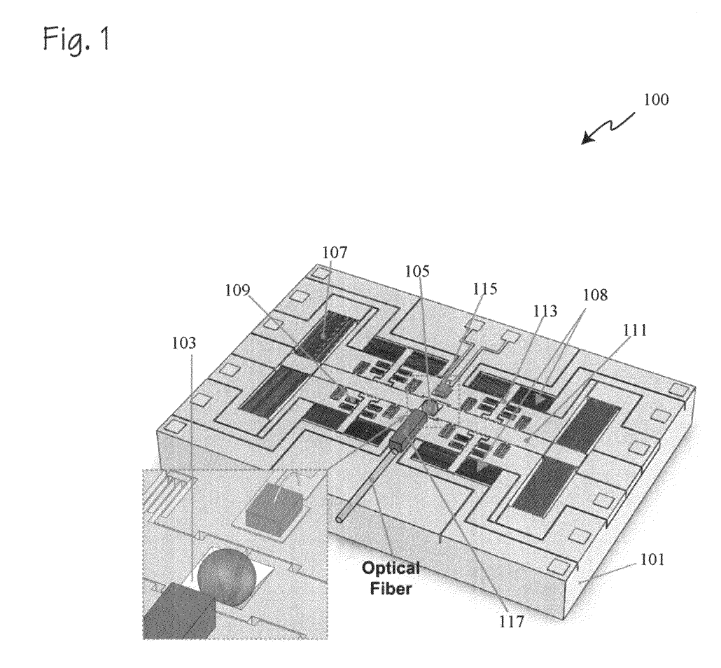

FIG. 1 shows an optical device according to an embodiment.

The optical device 100 includes a carrier 101 (e.g. a substrate, e.g. a silicon substrate) and a receiving chamber 103 in or on the carrier 101, wherein the receiving chamber 103 is configured to receive an optical element 105. The optical device 100 may further include the optical element 105 received in the receiving chamber 103 and a plurality of actuators 107. At least one of the receiving chamber 103 and the actuators 107 may be arranged and configured to adjust the position of the optical element 105 in the receiving chamber 103 in a direction perpendicular to the main surface of the carrier 101.

The carrier 101 may include a silicon substrate, e.g. a crystal silicon substrate, or a silicon on insulator (SOI) substrate. The carrier 101 is a MEMS platform with the receiving chamber 103 and the plurality of actuators 107, 108 arranged thereon. The MEMS platform may provide active alignment of optical elements 105 received on the MEMS platform 101 as described below. The optical element 105 is shown as a ball lens in this embodiment.

The receiving chamber 103 may be a groove, for example, a V-shape groove, for holding/receiving the optical element. The V-groove may be formed by extension parts of two opposite slope wedges, e.g. silicon slope wedges. The position of the ball lens 105 can be adjusted in two directions using the two specifically designed slope wedge structure. The two wedges holding the ball lens 105 can be moved in-plane by the actuators 107.

At least one of the receiving chamber 103 and the actuators 107, 108 is arranged and configured to adjust the position of the ball lens 105 in the receiving chamber 103 in one or two directions in-plane with the main surface of the carrier 101. In an embodiment, the actuators 107 may be configured to control the receiving chamber 103, e.g. by moving the slope wedges along a direction in-plane with the main surface of the carrier, so as to adjust the position of the ball lens 105 in the receiving chamber 103 in one or two directions in-plane with the main surface of the carrier 101.

In another embodiment, the actuators 107 may be configured to control the receiving chamber 103 to adjust the position of the ball lens 105 in a direction perpendicular to the main surface of the carrier 101 as will be described below.

The actuators 107, 108 include thermal or electro-thermal actuators, which are powered-on during the adjustment/alignment of the position of the ball lens 105 and are powered-off after the adjustment/alignment. The actuators 107, 108 may include folded beam suspension 109.

The optical device 100 may include one or more suspension arms 111 arranged on the carrier 101 and connected to the receiving chamber 103. The suspension arms 111 may be movable under the control of the actuators 107 to adjust the position of the ball lens 105 in the receiving chamber 103 in one or two directions in-plane with the main surface of the carrier 101. In an embodiment, the suspension arms 111 may be connected to the slope wedges of the receiving chamber 103. In another embodiment, the suspension arms 111 may include slope wedges at one end of the arms 111, wherein the slope wedges are arranged opposite to each other to form the receiving chamber 103.

The optical device 100 may further include at least one locking arm 113 configured to lock the receiving chamber 103 in a pre-defined position. The locking arm 113 may be arranged relative to the receiving chamber 103 and/or the suspension arms 111 to restrict the movement of the receiving chamber 103 and/or the suspension arms 111, so as to fix the position of the ball lens 105. For example, a respective set of locking arm 113 may be configured perpendicularly to each suspension arm 111 as shown in FIG. 1, with teeth on the locking arm 113 engaged with their counterparts in the suspension arm 111, so as to restrict the movement of the suspension arms 111. The locking arm 113 may be a micro-mechanical locking mechanism.

After alignment of the ball lens 105 through the movement of the receiving chamber 103 and/or the suspension arms 111 driven by the actuators 107, the final position of the ball lens 105 can then be constrained by, e.g., two micro-mechanical lockers 113. The micro-locking arms 113 may be driven by the actuators 108. The thermal actuators 108 on the micro-lockers need to be powered-on before moving the wedges and powered-off once the positioning is completed, making the ball lens 105 locked without maintaining power to the MEMS actuators 108 and micro-lockers 113.

In the above embodiments, the plurality of actuators 107, 108 may include actuators 107 configured to drive the suspension arm 111 and actuators 108 configured to drive the locking arm 103. The actuators 107 for driving the suspension arm 111 may also be referred to as main actuators. The actuators 108 for driving the locking arm 108 may be connected with the locking arm. In other embodiments, the same actuators may be used to drive both the suspension arm 111 and the locking arm 103, for positioning and fixing of optical element.

In an embodiment, the optical device 100 further includes a light source 115; which may be a laser, e.g. a laser diode (LD) 115, or other types of light source, e.g. a light emitting diode. The optical device 100 may further include one or more photonic chips 117. In this embodiment, a silicon waveguide chip 117 is arranged on the carrier 101 of the optical device 100. The position of the ball lens 115 is adjusted/aligned and locked in accordance with the above description, so that the ball lens 115 precisely couples the light from the light source 115 to the waveguide chip 117. The optical device 100 may further include an optical fiber coupled to the silicon waveguide chip 117.

The optical device 100 of FIG. 1 provides a MEMS active alignment platform which integrates electro-thermal actuators, micro-mechanical locking mechanism and optical element receiving chamber structure on a single substrate to achieve on chip fine positioning and mechanical locking of an optical element. In these embodiments, a MEMS-based two degree of freedom positioning device combined with a micro-locker structure for positioning and constraining optical elements, such as lens and fibers is presented.

The optical device 100 may further include an optical element holder as described in the embodiments below.

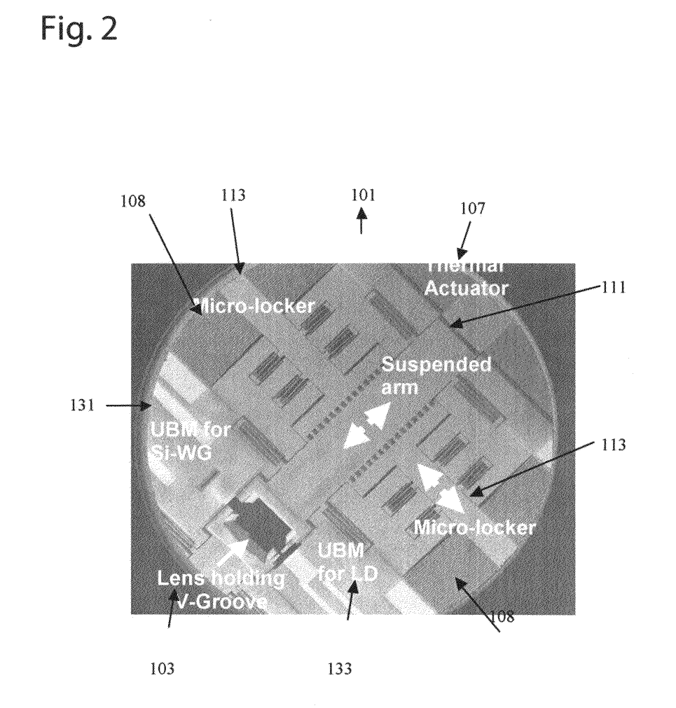

FIG. 2 shows a close view of the optical device according to an embodiment.

As shown in FIG. 2, lens holding V-groove 103, thermal actuator 107, 108, suspended arm 111, micro-locker 113, as well as UBM (under-bump-metallization) for Si waveguide 131 and UBM for laser diode (LD) 133 are arranged on the carrier 101 of the optical device.

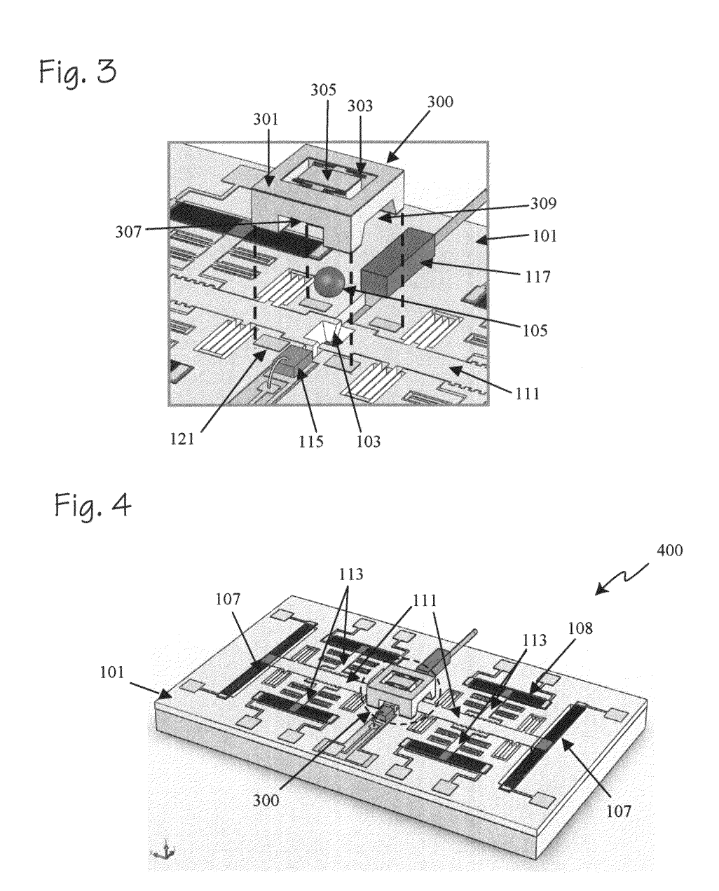

FIG. 3 shows an optical element holder according to an embodiment.

The optical element holder 300 is configured to hold an optical element, in this embodiment, a ball lens 105 against a receiving chamber 103 of a carrier 101. The optical element holder 300 may be referred to as a lens holder accordingly. The optical element holder 300 may include a frame 301, a biasing structure 303 arranged in the frame 301, and a suspended mass 305 supported by the biasing structure 303 and arranged in the top surface of the frame 301. The suspended mass 305, also referred as a lens holding mass, is movable in a direction perpendicular to the top surface of the optical element holder 300 to hold the optical element 105 in a pre-defined position, and the optical element holder 300 is configured to hold the optical element 105 under the suspended mass 305 in the frame 301.

The optical element holder 300 and the optical element 105 received in the frame 301 of the optical element holder 300 form an optical arrangement.

The frame 301 and the mass 305 may include at least one of silicon, silicon oxide, silicon nitride and metal layers, such as Al, Cr, Au, alloy and any combination thereof.

The biasing structure 303 may include at least one spring. In an example, the spring may be a serpentine spring. The spring may include one or more of silicon, silicon oxide, silicon nitride and metal layers, such as Al, Cr, Au, alloy and any combination thereof. The suspension mass 305 may be suspended symmetrically by a plurality of springs. In an embodiment, one, two, three, four or even more silicon springs may be provided, e.g. four springs provided at the four corners of the mass 305, respectively, to support the mass 305 located on the center of the top surface of frame 301. In other embodiments, other types of elastic object may be used in the biasing structure 303 to allow and at the same time limit the movement of the optical element in the direction perpendicular to the top surface of the optical element holder 300.

According to an embodiment, the optical element holder 300 is configured to limit the movement of the ball lens 105 in the direction perpendicular to the top surface of the optical element holder 300. The mass 305 may be moved in the direction perpendicular to the top surface of the optical element holder 300 under the external force, while the movement of the mass 305 along other directions is limited due to special spring design of the biasing structure 303. Accordingly, the suspended mass 305 may further limit the movement of the ball lens 105 held under the suspended mass 305. The top surface of the optical element holder 300 is parallel to the main surface of the carrier 101 when the ball lens 105 is held between the optical element holder 300 and the carrier 101.

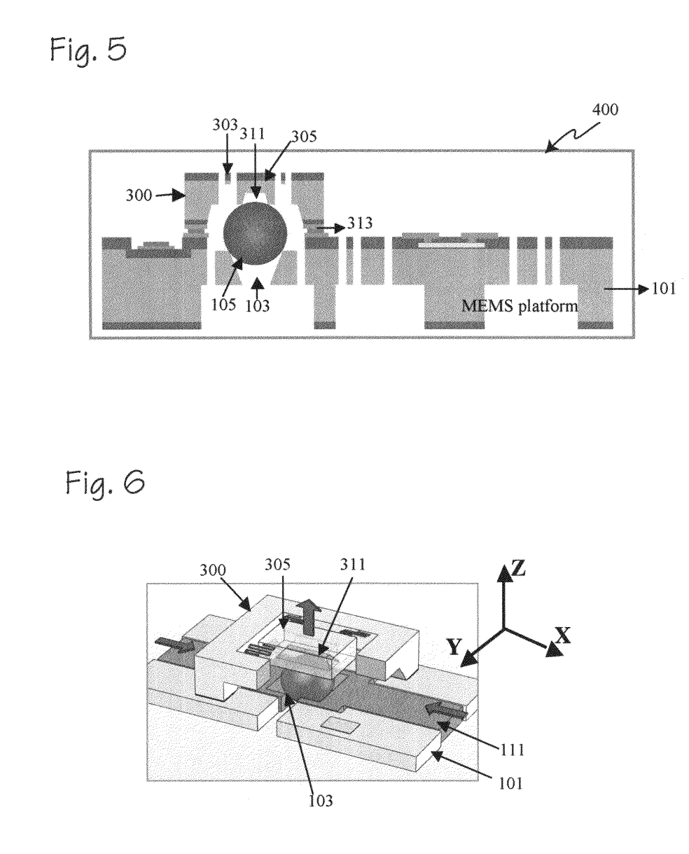

According to an embodiment, the suspended mass 305 may include a groove (as shown in FIGS. 5 to 8 below) on the bottom side, wherein the groove is configured to engage the ball lens 105 when the ball lens 105 is held under the suspended mass 305. The groove may limit or regulate the movement of the ball lens 105 as described in more detail below.

An optical arrangement may be provided which includes the optical element holder 300 described in various embodiments and the optical element 105 received in the frame of the optical element holder 300.

The optical element holder 300 may be assembled on the MEMS platform carrier 101 together with the ball lens 105 to form an optical device. Before assembling the optical element holder 300, the ball lens 105 is placed in the V-groove receiving chamber 103. Other photonic chip and light source may also be arranged on the carrier 101 and aligned with the ball lens 105 such as e.g. one or more other photonic chips and/or one or more other laser diodes and/or one or more other light emitting diodes.

In assembly, the optical element holder 300, being a MEMS structure, is attached to the MEMS platform carrier 101 as described above, and is arranged above the receiving chamber 103 of the carrier 101 to hold the ball lens 105 between the optical element holder 300 and the receiving chamber 101. There are four anchors on the four corners of the frame 301, for example. The anchors may be bonded to the metal pads 121 on the surface of the MEMS platform carrier 101 using metal soldering process. For example, the anchors may include metal pads 313 as shown in FIG. 5 below for soldering process. The metal bonding pads 121 are located on the solid part of the carrier 101, and thus the frame structure 301 of the holder 300 is fixed after the assembly and bonding processes.

The carrier 101 may include a plurality of actuators and one or more suspension arms arranged thereon, which are configured to adjust/align the position of the ball lens 105 as described in FIG. 1 above.

Channels may be formed on the sidewalls of the frame 301 of the optical element holder 300. As shown in FIG. 3, one channel 307 is formed through two opposing sidewalls of the frame 301 to allow the light from the LD 115 to pass through the ball lens 105 and couple to the waveguide 117. On the other two opposing sidewalls of the frame 301, another channel 309 is formed to allow the free movement of the suspension arms 111 on the MEMS platform carrier 101 during the alignment process.

FIG. 4 shows an optical device 400 obtained after assembling the optical element holder 300 on the carrier 101 of the optical device 100 of FIG. 1 according to an embodiment.

FIG. 5 shows the cross-sectional view of the optical device 400 of FIG. 4.

In the optical device 400 of FIGS. 4 and 5, the MEMS platform 101 includes three major components: the lens holding V-groove 103, the main adjusting actuators 107 and the locking mechanisms 113. The ball lens 105 is hosted by the V-groove 103, which may be formed by the extension parts of the two opposite slope silicon wedges. The suspension arms 111 can move in-plane driven by the main adjusting actuators 107 to achieve 2-D movements of the ball lens 105. Two sets of locking mechanisms 113 are configured perpendicularly to each suspension arm 111 with silicon teeth on the locking arm engaged with their counterparts. The locking mechanisms 113 may be driven by actuators 108. The lens holder 300 in conjunction with the optical device 100 provides the movement of the ball lens 105 in a third direction perpendicular to the main surface of the MEMS platform 101, thereby achieving 3-D alignment and mechanical fixing of the optical element as described in more detail below.

In FIG. 5, a groove 311 is shown on the bottom side of the suspended mass 305, wherein the groove 311 is configured to engage the ball lens 105 when the ball lens 105 is held under the suspended mass 305. The groove 311 may be a V-groove or illustratively a U-shaped groove, for example. The groove 311 may guide the movement of the ball lens 105 along the longitudinal direction of the groove 311, and may limit the movement of the ball lens 105 in a direction in-plane with the main surface of the carrier 101 and perpendicular to the longitudinal direction of the groove 311. The groove 311 in the optical element holder 300 may be arranged perpendicularly to the V-groove receiving chamber 103 on the MEMS platform carrier 101, as more clearly shown in FIG. 6.

Metal pads 313 are formed on the back side of the frame 301 of the optical element holder 300, and may be used in soldering process for attaching the optical element holder 300 to the MEMS platform 101.

FIG. 6 illustrates the 3-D holding mechanism of the optical element holder according to an embodiment.

As shown in FIG. 6, the optical element holder 300 is attached on the MEMS platform 101 of the optical device 100. For illustration purposes, X-Y-Z axes are used to represent the various directions. X-axis and Y-axis represent two directions in-plane with the main surface of the MEMS platform 101 and the optical element holder 300, wherein the two directions are perpendicular to each other. Z-axis represents the direction perpendicular to the main surface of the MEMS platform 101 and the optical element holder 300.

When the two suspension arms 111 move oppositely along X-axis, e.g., driven by the actuators, the ball lens 105 located on the receiving chamber 103, e.g., formed by the silicon slope wedges, will move up and down along Z-axis driven by the slope wedges. The suspended mass 305 on the optical element holder 300 may serve as a stopper and limits the movement of the ball lens 105. The restoring forces on the deformed spring are applied onto the ball lens 105, and make the movement of the ball lens 105 in the direction of Z-axis harder.

The thickness of the mass 305 is controlled by wet anisotropic etching process, and a small V-groove 311 is formed on the bottom side of the mass 305 as described in FIG. 5 above. The longitudinal direction of the V-groove or U-groove 311 is along with the direction of the suspension arm 111 (X-axis) on the MEMS platform. This rectangular V-groove 311 may guide the ball lens 105 during the alignment process and limit the movement of the ball lens 105 in the Y-axis direction. Accordingly, the adjustment movement of the ball lens 105 is enabled in X-Z plane to achieve alignment in X-Z plane without changing the position along the focal length. The adjustment movement of the ball lens 105 is restricted in the direction of Y axis. Thus, 3-axis alignment and fixing of the ball lens 105 is achieved by the lens holder 300 in conjunction with the MEMS platform 101 which provides 2-axis alignment and locking of ball lens as described before.

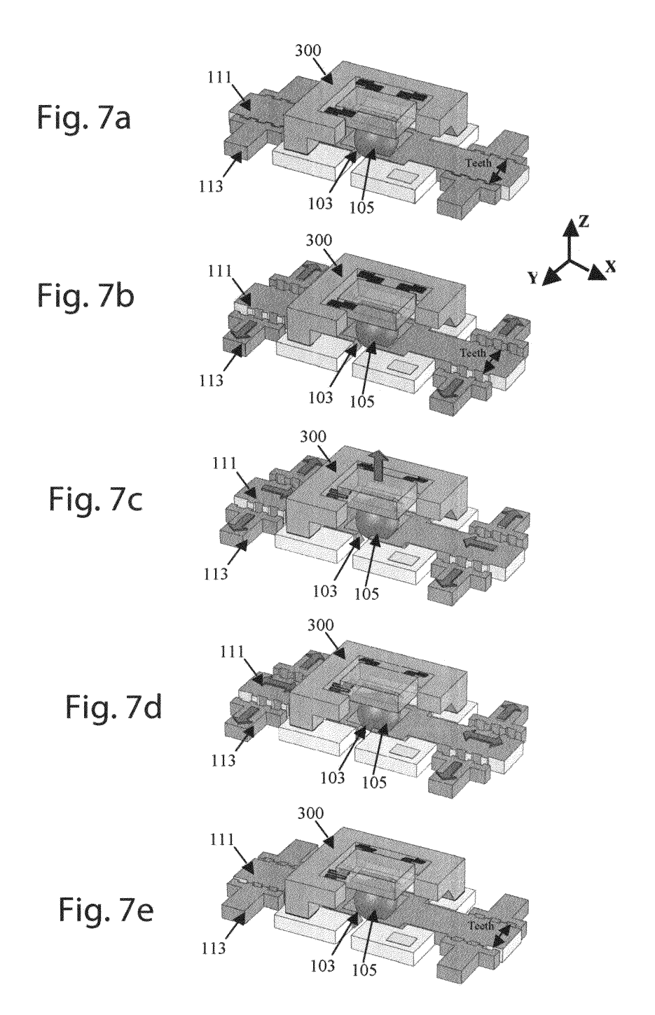

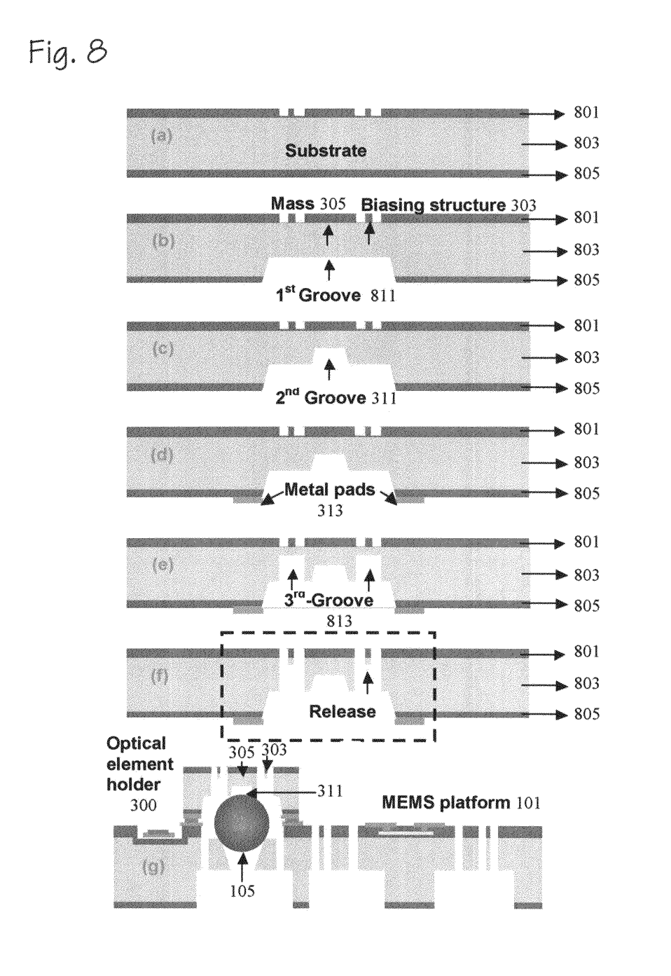

FIG. 7 illustrates the alignment and locking process of the optical device 400 shown in FIGS. 4 and 5 above according to an embodiment.

In FIG. 7(a), an initial state of the optical device 400 is shown. The ball lens 105 is located in the receiving chamber 103 which is connected to the suspension arms 111. The teeth, e.g., Si-teeth, on the locking arms 113 and on the suspension arms 111 are engaged correspondingly.

In FIG. 7(b), a first state of the optical device 400 is shown, wherein the locking arms 113 are pulled out to allow the movement of the suspension arms 111.

In FIG. 7(c), a second state of the optical device 400 is shown, wherein the location of the locking arms 113 is kept in the unlocked state. The actuators are configured to move the suspension arms 111. In this embodiment, the relative position of the two suspension arms 111 is changed, so as to move the ball lens 105 along X-axis and Z-axis. The movement of the ball lens 105 along Y-axis is restricted by the V-groove on the back side of the suspension mass of the optical element holder 300. In this manner, the alignment of the ball lens 105 along Z-axis is achieved.

In FIG. 7(d), a third state of the optical device 400 is shown, wherein the location of the locking arms 113 is still kept in the unlocked state. The relative position of the suspension arms 111 is kept, which may keep the position of the ball lens 105 along Z-axis. The suspension arms 111 are moved together with the ball lens 105 along X-axis. The movement of the ball lens 105 along Y-axis is restricted by the optical element holder 300. In this manner, the alignment of the ball lens 105 in X-axis is achieved.

In FIG. 7(e), a fourth state of the optical device 400 is shown. The locking arms 113 are released to lock the suspension arms, thereby fixing the position of the ball lens 105 determined in the alignment process above.

FIG. 8 shows a process illustrating a method for fabricating the optical element holder according to an embodiment.

In FIG. 8(a), an oxide layer 801 is deposited on a substrate 803. In an embodiment, the substrate is a silicon substrate or a SOI substrate. The oxide layer may be a silicon oxide. The oxide layer may be deposited on the substrate by plasma-enhanced chemical vapor deposition (PECVD) or other suitable process. In an embodiment, the thickness of the oxide layer is 1.0 μm.

In FIG. 8(b), the oxide layer is patterned to define a biasing structure 303 and a suspended mass 305. The biasing structure 303 may include one or more springs.

An oxide layer 805 may be arranged below the substrate 803. After a partial oxide etching using reactive-ion etching (RIE) process or other suitable etching process, a groove may be formed on the backside of the substrate 803. A first groove 811 is formed under the biasing structure 303 and the suspended mass 305 by etching from the back side of the substrate 803. The first groove 811 may be a V-groove, for example. The first groove 811 may form at least one of the channels 307, 309 formed through two opposing sidewalls of the frame 301 of the optical element holder 300 described in FIG. 3 above. Wet anisotropic silicon etching may be used to form the first groove 811.

In FIG. 8(c), a second groove 311 is formed within the suspended mass 305 by etching from the first groove 811. The size of the second groove 311 is smaller than the size of the first groove. The second groove 311 may be a V-groove. The patterning may be performed within the first groove 811 to form the second groove 311 inside the suspended mass 305. The second groove 311 may form the groove 311 at the back side of the optical element holder 300 as shown in FIGS. 5 and 6 above.

In FIG. 8(d), one or more metal pads 313 are formed on the back side of the substrate 803. The metal pads 313 may be bonded onto the metal pads 121 formed on the carrier 101 (as shown in FIG. 3), so as to attach the optical element holder 300 to the carrier 101.

In FIG. 8(e), one or more third grooves 813 are formed under the biasing structure 303 by etching from the first groove 811. The third groove 813 may be a U-groove, for example. The third groove 813 may be formed by deep reactive-ion etching (DRIE) process or other suitable etching process from the backside of the substrate 803.

In FIG. 8(f), the biasing structure 303 and the suspended mass 305 are released from the underlying substrate 803 by etching from the front side of the substrate 803. The etching may be performed using DRIE process or other suitable etching process.

In FIG. 8(g), the optical element holder structure 300 including the biasing structure and the suspended mass as formed in the above process is assembled onto a MEMS platform 101 to form an optical device 400 as described in the embodiments above.

According to various embodiments, a MEMS optical element holder structure is developed on a bulk silicon substrate using combined wet etch of silicon and DRIE process. The optical element holder structure is attached onto a MEMS platform described above including 2-D MEMS aligning component and mechanical locking components, to achieve 3-D alignment and mechanical locking of an optical element. The optical element is fixed in x-axis and y-axis directions in-plane with the main surface of the MEMS platform by in-plane micro-lockers, and is fixed in z-axis direction by the optical element holder with suspended mass. The optical element holder in conjunction with the MEMS platform is capable of performing active mechanical locking by combined mechanical restoring force and friction force. The mechanical locking is dependent on the restoring force from the springs due to its deformation. Thus, a strong locking force and stable locking can be achieved. The positioning and locking process according to various embodiments can be implemented without visualization and is reversible.

The integrated configuration with coarse assembly requirement can provide precise active alignment and off alignment locking function with sub-micro precision and repeatability, wherein re-alignment and re-locking is possible.

The optical device and optical arrangement described in various embodiments provide active alignment and fixing of optical elements or photonic components or any devices that need precision alignment and locking in photonics packaging.

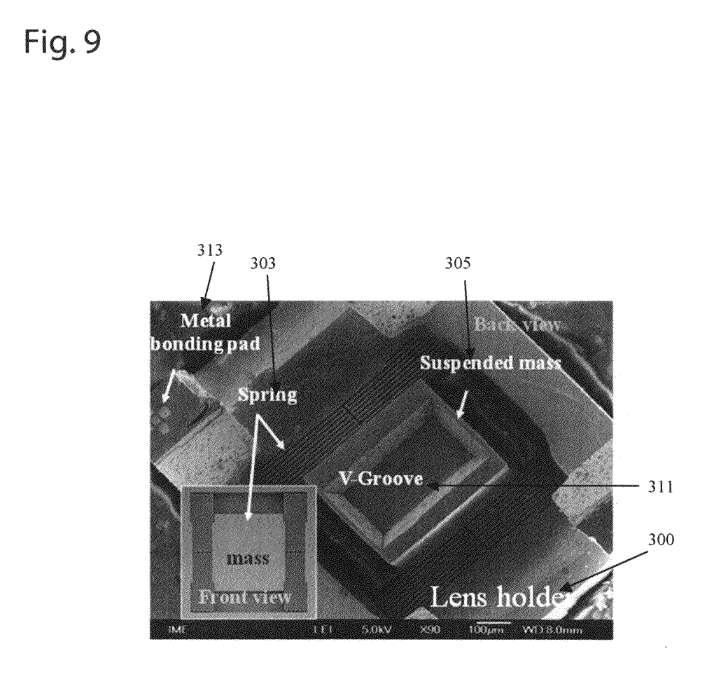

FIG. 9 shows the SEM micrographs of the fabricated optical element holder structure according to an embodiment.

From the backside view, the V-groove 311 on the back side of the suspended mass 305 is clearly shown. Four sets of long folded beams 303, e.g. including silicon material, are arranged to support the suspended mass 305. The folded beams 303 form springs. Metal bonding pads 313 are also shown on the back side of the lens holder 300 for bonding the lens holder 300 to a carrier. The inset picture shows the front side view of the suspended mass 305 and the suspended springs 303.

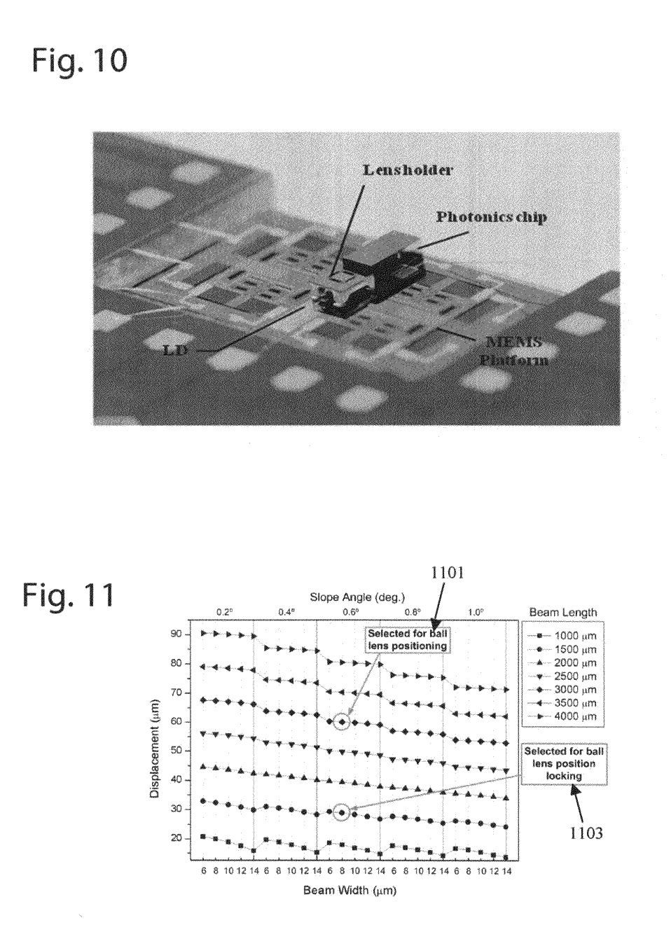

FIG. 10 shows an optical device assembly according to an embodiment.

In FIG. 10, the sub-assembly of the platform used for characterization is shown, wherein a laser diode, a photonics chip and a lens holder are flip-chip bonded onto a MEMS platform. The laser diode and the photonics chip are arranged at the two opposing sides of the lens holder, respectively. The laser diode, the lens underneath the lens holder, and the photonics chip are aligned on the same optical path.

FIG. 11 shows the simulated maximum displacement of the actuator as a function of the geometric dimensions according to an embodiment.

In FIG. 11, FE (finite element) simulation results of the maximum displacement of the electro-thermal V-beam actuator with different geometric dimensions without external load is shown, wherein the highest temperature on the beam is 600 K. For example, point 1101 shows the simulation result of a design of the main actuators (e.g. the actuators 107 in FIGS. 1, 2, and 4) configured to drive the suspension arms 111, for example, wherein V-beams of the main actuators have a beam length of 3000 μm, a beam width of 8 μm and an arm (slope) angle of about 0.6°. Point 1103 shows the simulation result of a design of the actuators (e.g. the actuators 108 in FIGS. 1, 2, and 4) configured to drive the micro-lockers 113, for example, wherein V-beams of these actuators have a beam length of 1500 μm, a beam width of 8 μm and an arm (slope) angle of about 0.6°. As shown in FIG. 11, the maximum displacement 1101 required for the actuators for driving the suspension arms is about 60 μm, different from the maximum displacement 1103 of about 30 μm required for the actuators for driving the micro-lockers, due to the different functions and designs of these two types of actuators.

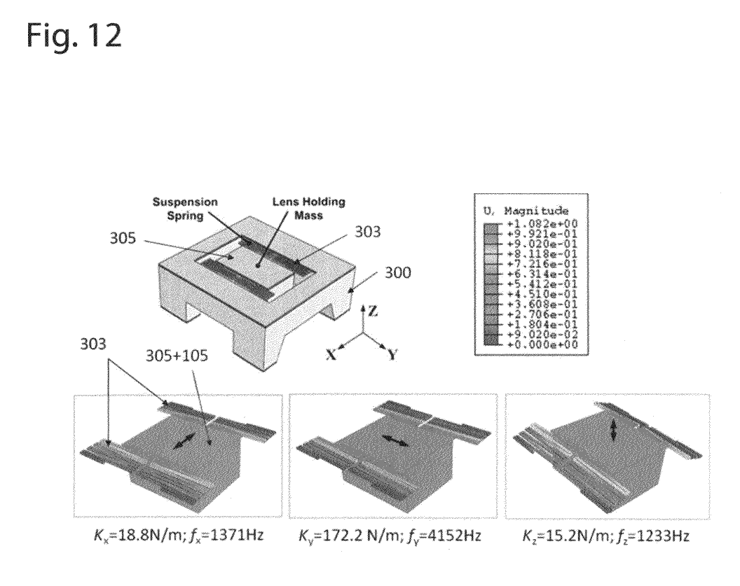

FIG. 12 shows 3D simulation of an optical element holder under forces along three directions according to an embodiment.

In FIG. 12, the effectiveness and stability of a suspension system including folded springs and the suspended lens holder/ball lens are verified by 3D simulation. The lens holder 300 includes a suspended mass 305 supported by a biasing structure 303 (e.g. the springs), and holds a ball lens 105 under the suspended mass 305, as shown in FIG. 12. Simulation results of the resonant frequencies of the suspended mass together with the ball lens along different axis are shown. The position of the ball lens is fixed by the locking mechanism of the embodiment without electrical supply. Simulation results indicated that the optical element locked by the suspended lens holder in conjunction with the MEMS platform is capable of resisting external vibration disturbance along X- , Y- and Z-axis directions with frequencies lower than 1 kHz and ensure submicron locking function. For example, the simulation results show a stiffness k of 18.8 N/m and a resonance frequency fₓ of 1371 Hz along X-axis, a stiffness k of 172.2 N/m and a resonance frequency f_{y} of 4152 Hz along Y-axis, and a stiffness k of 15.2 N/m and a resonance frequency f₂ of 1233 Hz along Z-axis.

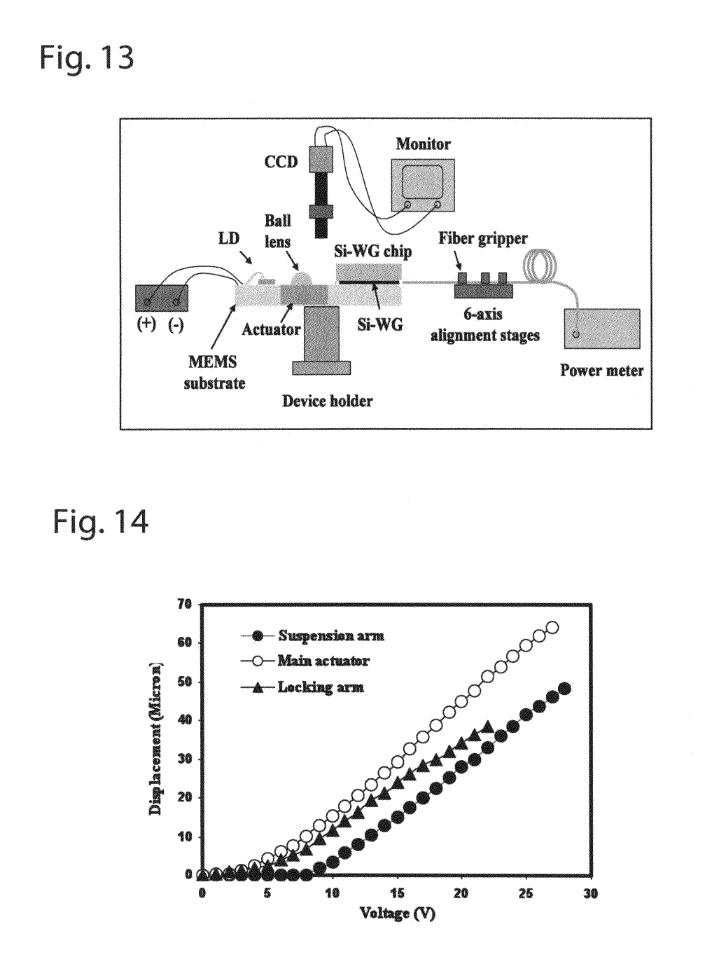

FIG. 13 shows a schematic experiment setup for testing optical coupling using MEMS actuators according to an embodiment. As shown in FIG. 13, the testing setup is configured to test optical coupling between the LD and Si-waveguide chip through the ball lens using MEMS actuators provided on the MEMS platform according to an embodiment. Experiment results based on the experiment setup of FIG. 13 are illustrated in FIGS. 14 to 16 below.

FIG. 14 shows the characterization of the actuators according to an embodiment. The displacement of main adjusting actuator (e.g. the actuators 107 in FIG. 1), the suspension arm and the locking arms versus the driving voltage is illustrated. In this embodiment, the actuators (e.g. the actuators 108 in FIG. 1) for driving the locking arms are connected with the locking arms, and accordingly the displacement-voltage curve of the locking arm as shown in FIG. 14 also represents the displacement-voltage curve of the actuators for driving the locking arm. It was observed that to move the suspension arm in-plane for 30 μm, the driving voltage applied onto the main adjusting actuator is up to 23V wherein the actuator alone can move about 50 μm without external load. The results showed that the maximum displacements of 60 μm and 30 μm can be achieved for the main actuators (e.g. the actuators 107 in FIG. 1) for driving the suspension arm and the actuators for driving the micro-locker (e.g. the actuators 108 in FIG. 1), respectively, by using electrical-thermal actuators of the designs 1101, 1103 selected in FIG. 11, for example.

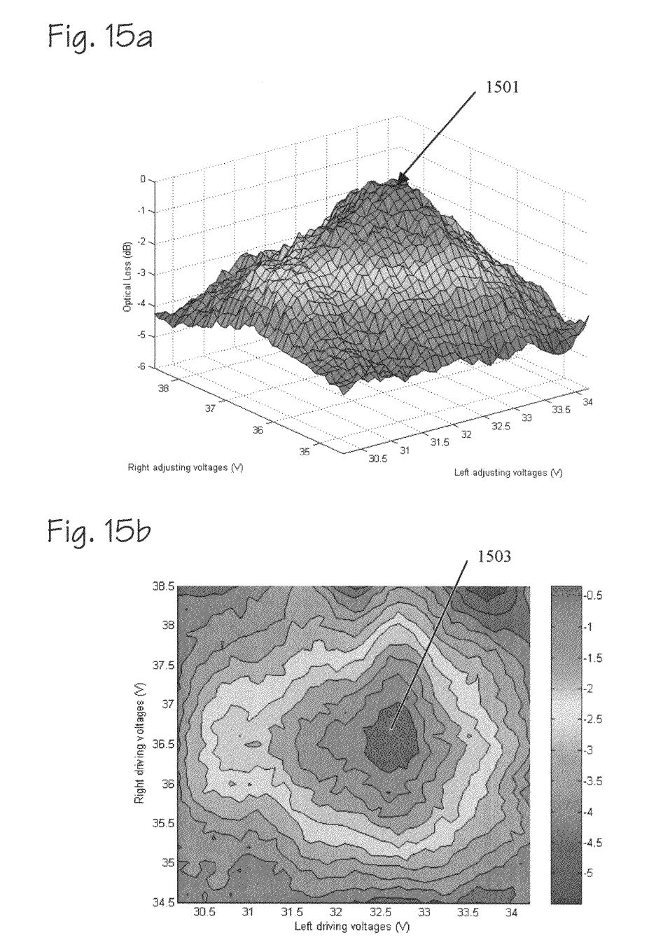

FIG. 15(a) illustrates coupling loss of waveguide-to-laser diode versus the alignment of the ball lens. For example, the values of the left adjusting voltage may be shown along X-axis, the values of the right adjusting voltages may be shown along Y-axis, and the optical loss may be shown along Z-axis, to illustrate the different coupling loss of waveguide-to-LD with variant adjusting voltages applied to the left and right actuators. When the biases on the two main adjusting actuators are adjusted, the coupled light power reached the optimum point 1501. The preliminary results have shown that the MEMS platform is able to host the ball lens in a coarse aligned position and then, carry out the fine alignment procedure.

FIG. 15(b) illustrates coupling loss of fiber-to-waveguide versus the alignment of the ball lens. The results showed that when the voltage applied on the left side actuator (e.g. the actuator 107 in FIG. 1) was about 32.5V and the voltage applied on the right side actuator (e.g. the actuator 107 in FIG. 1) was about 36.5V, the optical coupling loss between silicon waveguide and fiber reaches its optimum point 1503. These results demonstrated the feasibility to fine-tune optical coupling between optical fiber and silicon waveguide through the MEMS components of various embodiments.

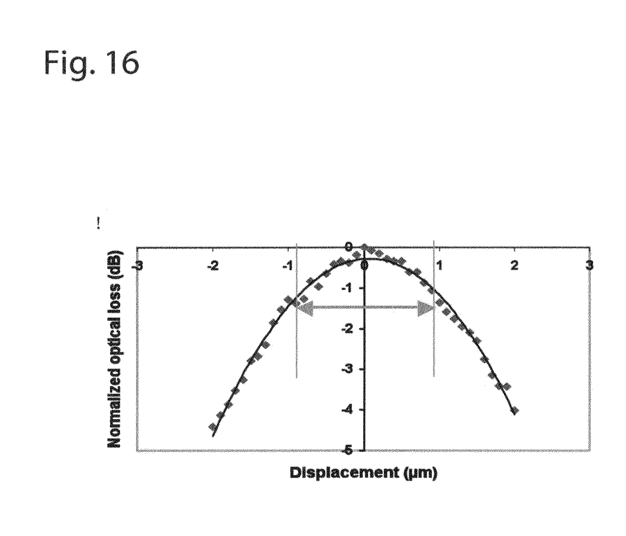

FIG. 16 illustrates the optical coupling loss versus the displacement according to an embodiment.

The curve showed in FIG. 16 indicates that +/−0.7 μm precision between the ball lens and the Si-waveguide has been achieved which results in low optical coupling loss of <1 dB. The results showed that through sub-micron fine-positioning of the ball lens, less than 1 dB optical coupling loss between LD and silicon waveguide can be obtained.

Thermal crosstalk between the adjusting actuator and the locker is observed. According to an embodiment, additional trench structures may be added to isolate the heat from the different thermal actuators.

The embodiments above describe a MEMS spring suspended lens holding mechanism attached to an active alignment platform with micro-positioning and locking function. The integrated system provides precise “in packaging alignment” for optical components, such as lens and optical fiber, and improves optical coupling efficiency between optical components. The operation procedures have lower requirements to operator's skill, with the high stability of the structure ensuring high alignment accuracy. The embodiments use wafer/chip level micromachining technologies, such as lithograph patterning and die attachment rather than using expensive precision bonders, thereby reducing time consumption and saving total cost. Thus, the alignment complexity and cost can be reduced according to the embodiments.

The experiment results above show the potential application of the optical device/arrangement including the MEMS platform and/or optical element holder in hybrid integrated Si photonics and applications that includes LD-ball lens-silicon waveguide coupling system, e.g., transmitter or transceiver.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

We claim:

1. An optical device, comprising:
a carrier;
a light source;
a receiving chamber in or on the carrier, wherein the receiving chamber is configured to receive an optical element;
the optical element received in the receiving chamber;
a plurality of actuators;
a waveguide arranged to receive light transmitted from the light source through the optical element;
wherein at least one of the receiving chamber and the actuators is arranged and configured to adjust the position of the optical element in the receiving chamber in a first direction perpendicular to the main surface of the carrier and in a second direction in-plane with the main surface of the carrier.

2. The optical device of claim 1, further comprising:
an optical element holder positioned above the receiving chamber and configured to hold the optical element in a pre-defined position.

3. The optical device of claim 2,
wherein the optical element holder is configured to limit the movement of the optical element in the first direction perpendicular to the main surface of the carrier, and in a third direction in-plane with the main surface of the carrier and perpendicular to the second direction.

4. The optical device of claim 2,
wherein the optical element holder comprises a biasing structure to hold the optical element in the pre-defined position.

5. The optical device of claim 4,
wherein the biasing structure comprises at least one spring.

6. The optical device of claim 1,
wherein at least one of the receiving chamber and the actuators is arranged and configured to adjust the position of the optical element in the receiving chamber in one or two directions in-plane with the main surface of the carrier.

7. The optical device of claim 1,
wherein the optical device comprises one or more suspension arms arranged on the carrier and connected to the receiving chamber,
wherein the suspension arms are movable under the control of the actuators to adjust the position of the optical element in the receiving chamber in one or two directions in-plane with the main surface of the carrier.

8. The optical device of claim 1,
wherein the optical element comprises a ball lens.

9. The optical device of claim 1, further comprising:
at least one locking arm configured to lock the receiving chamber in a pre-defined position.

10. An optical device, comprising:
a carrier;
a receiving chamber in or on the carrier, wherein the receiving chamber is configured to receive an optical element;
the optical element received in the receiving chamber;
a plurality of actuators;
wherein at least one of the receiving chamber and the actuators is arranged and configured to adjust the position of the optical element in the receiving chamber in a direction perpendicular to the main surface of the carrier.

11. An optical arrangement, comprising an optical element holder for holding an optical element against a receiving chamber of a carrier, the optical element holder comprising:
a frame,
a biasing structure arranged in the frame, and
a suspended mass supported by the biasing structure and arranged in the top surface of the frame;
wherein the suspended mass is movable in a direction perpendicular to the top surface of the optical element holder to hold the optical element in a pre-defined position, and wherein the optical element holder is configured to hold the optical element under the suspended mass in the frame; and
the optical element received in the frame of the optical element holder.

12. The optical arrangement of claim 11,
wherein the optical element holder is configured to limit the movement of the optical element in the direction perpendicular to the top surface of the optical element holder.

13. The optical arrangement of claim 11,
wherein the suspended mass comprises a groove on the bottom side, the groove being configured to engage the optical element.

14. The optical arrangement of claim 13,
wherein the optical element holder is configured to limit the movement of the optical element in a direction in-plane with the main surface of the carrier and perpendicular to the longitudinal direction of the groove.

15. The optical arrangement of claim 11,
wherein the optical element holder is attached to the carrier and is arranged above the receiving chamber of the carrier to hold the optical element between the optical element holder and the receiving chamber.

16. The optical arrangement of claim 15,
wherein the carrier comprises a plurality of actuators,
wherein the at least one of the receiving chamber and the actuators is arranged and configured to adjust the position of the optical element in the receiving chamber in a direction perpendicular to the main surface of the carrier and in a direction in-plane with the main surface of the carrier.

17. The optical arrangement of claim 16,
wherein the optical arrangement comprises one or more suspension arms arranged on the carrier and connected to the receiving chamber,
wherein the suspension arms are movable under the control of the actuators to adjust the position of the optical element in the receiving chamber in one or two directions in-plane with the main surface of the carrier.

18. An optical element holder for holding an optical element against a receiving chamber of a carrier, the optical element holder comprising:
a frame;
a biasing structure arranged in the frame; and
a suspended mass supported by the biasing structure and arranged in the top surface of the frame;
wherein the suspended mass is movable in a direction perpendicular to the top surface of the optical element holder to hold the optical element in a pre-defined position.

19. A method for operating an optical device, the optical device comprising a carrier, an optical element holder and an optical element held by the optical element holder against a receiving chamber of the carrier, the method comprising:
disengaging at least one locking arm from the receiving chamber, the locking arm being arranged on the carrier to lock the receiving chamber in a pre-defined position;
moving at least one suspension arms arranged on the carrier and connected to the receiving chamber, thereby adjusting the position of the receiving chamber; and
engaging the locking arm to the receiving chamber, thereby locking final positions of the receiving chamber and the optical element received in the receiving chamber.

20. A method for fabricating an optical element holder, the method comprising:
depositing an oxide layer on a substrate;
patterning the oxide layer to form a biasing structure and a suspended mass;
etching from the back side of the substrate to form a first groove under the biasing structure and the suspended mass;
etching from the first groove to form a second groove within the suspended mass, the size of the second groove being smaller than the size of the first groove;
forming one or more metal pads on the back side of the substrate;
etching from the first groove to form one or more third grooves under the biasing structure;
etching from the front side of the substrate to release the biasing structure and the suspended mass from the underlying substrate.
